(19) United States
(12) Patent Application Publication
(10) Pub. No.: US 2025/0005749 A1
(43) Pub. Date: Jan. 2, 2025

(54) IMAGE ENHANCEMENT OF MEDICAL IMAGES

(71) Applicant: Novocure GmbH, Root D4 (CH)

(72) Inventors: Noa URMAN, Haifa (IL); Yana GLOZMAN, Haifa (IL)

(73) Assignee: Novocure GmbH, Root D4 (CH)

(21) Appl. No.: 18/744,991

(22) Filed: Jun. 17, 2024

Related U.S. Application Data
(60) Provisional application No. 63/524,574, filed on Jun. 30, 2023.

(51) Int. Cl. G06T 7/00; G06T 3/40; G06T 5/40; G06T 5/50; G06T 7/30; G06V 10/25

(52) U.S. Cl. CPC G06T 7/0012; G06T 3/40; G06T 5/40; G06T 5/50; G06T 7/30; G06V 10/25; G06T 2207/10088; G06T 2207/20221; G06T 2207/30096

(57) ABSTRACT

A computer-implemented method for enhancing a medical image, the method comprising: obtaining a first medical image of a subject, the first medical image having a plurality of voxels, the first medical image missing voxels in a portion of a region of interest; obtaining a second medical image of the subject, the second medical image having a plurality of voxels, the second medical image having voxels in the portion of the region of interest; and generating a combined medical image based on the first medical image and the second medical image, wherein the combined medical image is not missing voxels in the portion of the region of interest.

### CROSS-REFERENCE TO RELATED APPLICATIONS

This application claims priority to U.S. Provisional Application No. 63/524,574, filed Jun. 30, 2023, which is incorporated herein by reference in its entirety.

### BACKGROUND

Tumor treating fields (TTFields) are low intensity alternating electric fields within the intermediate frequency range (for example, 50 kHz to 1 MHz), which may be used to treat tumors as described in U.S. Pat. No. 7,565,205. TTFields are induced non-invasively into the region of interest by transducers placed on the patient's body and applying alternating current (AC) voltages between the transducers. Conventionally, transducers used to generate TTFields include a plurality of electrode elements including ceramic disks. One side of each ceramic disk is positioned against the patient's skin, and the other side of each disc has a conductive backing. Electrical signals are applied to this conductive backing, and these signals are capacitively coupled into the patient's body through the ceramic discs. Conventional transducer designs include arrays of ceramic disks attached to a subject's body via a conductive skin-contact layer such as a hydrogel. AC voltage is applied between a pair of transducers for an interval of time to generate an electric field with field lines generally running in the front-back direction. Then, AC voltage is applied at the same frequency between at least another pair of transducers for another interval of time to generate an electric field with field lines generally running in the right-left direction. The system then repeats this two-step sequence throughout the treatment.

### BRIEF DESCRIPTION OF THE DRAWINGS

FIG. 1 depicts an example method for generating a combined medical image.

FIG. 2 depicts an example method for performing image matching based on histograms.

FIG. 3 depicts an example method for performing image matching based on checkboard images.

FIG. 4 depicts an example method for performing image matching based on checkboard images.

FIG. 5 depicts an example flowchart for performing the example method described in FIGS. 1-4.

FIG. 6 depicts an example apparatus to apply alternating electric fields to a subject's body.

FIGS. 7A and 7B depict schematic views of exemplary design of a transducer for applying alternating electric fields.

FIG. 8 depicts an example placement of transducers on a subject's head.

FIG. 9 depicts an example computer apparatus.

### DESCRIPTION OF EMBODIMENTS

This application describes exemplary techniques utilizing computer algorithms for enhancing medical images missing information, such as having slices missing, being truncated, or having a lower resolution.

When administering TTFields to a subject, such as a patient, one or more medical images are read and analyzed to determine a treatment plan for the subject. Traditionally, it may take approximately an hour to obtain a set of full resolution medical image(s) of the subject, while a rapid-taken medical image may only take several minutes. However, a rapid-taken medical image may not have complete information, such as having lower resolution or missing slices, and may not provide the most accurate determination.

The inventors recognized that during a procedure of reading the medical images for TTFields treatment determination, a need exists for filling and enhancing medical images that have missing information or have a low quality based on existing medical images of the same subject with full or better information.

The methods and systems described herein provide a practical application to fill in and/or enhance a medical image having missing voxels. By filling in and/or enhancing such a medical image, a more complete view of a subject can be obtained having more information about the subject. With a medical image having more information on the subject, a more accurate three-dimensional computational model of the subject can be obtained. With a more accurate three-dimensional computational model of the subject, a more accurate determination of where to place transducer arrays on the subject for delivering TTFields can be obtained.

In particular, the inventors discovered computational techniques to fill in and/or enhance a medical image having missing voxels. Exemplary methods and systems provide for filling missing portions of a first medical image based on a second medical image that has voxels covering the missing portions and generating a combined medical image. In some embodiments, computer algorithm techniques may use histogram matching of the first and second medical images to generate the combined medical image. In some embodiments, computer algorithm technique may use a checkerboard algorithm that generates first and second weighting maps (based on first and second checkerboard images) and combines weighted first and second medical images to generate the combined medical image.

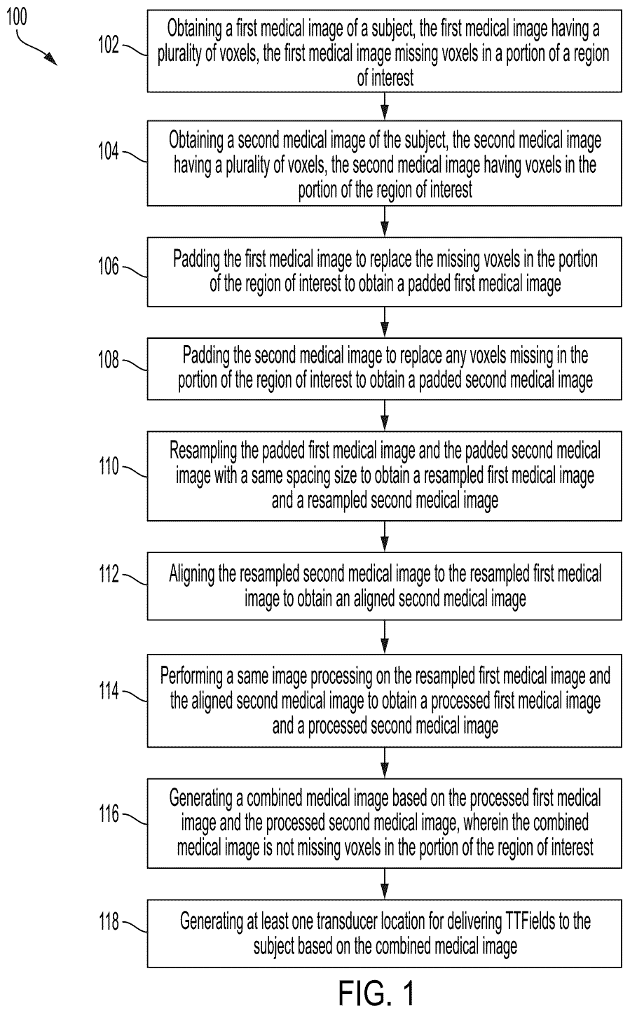

FIG. 1 depicts an example computer-implemented method 100 for generating a combined medical image based on a first medical image and a second medical image of a subject. The method 100 may be implemented by a computer, the computer including one or more processors and memory accessible by the one or more processors, the memory storing instructions that when executed by the one or more processors cause the computer to perform the steps of the method 100. Modifications, additions, or omissions may be made to the method 100, as well as the other methods described herein. While an order of operations is indicated in FIG. 1, as well as the other methods described herein, for illustrative purposes, the timing and ordering of such operations may vary where appropriate without negating the purpose and advantages of the examples set forth herein.

The method 100 may include, at step 102, obtaining the first medical image of the subject, wherein the first medical image may have a plurality of voxels and may be missing voxels in a portion of a region of interest. The medical image may be, for example, an X-ray image, a magnetic resonance imaging (MRI), a computerized tomography (CT) image, an ultrasound image, or any image providing an internal view of the subject's body. For example, in some embodiments, the first medical image is missing slices in a portion of the region of interest. In some embodiments, the first medical image is truncated in a portion of the region of interest. For example, in a head scan of the subject, the first medical image may be missing a top of the head of the subject. In some embodiments, the first medical image has a low resolution in a portion of the region of interest. For example, as to low resolution, the first medical image may use resolution of 512×512 with a spacing of approximately 3 mm to approximately 5 mm between planes. A medical image with a high resolution may use resolution of 512×512 with a spacing of approximately 1 mm between planes. A medical image with a medium resolution may use resolution of 512×512 with a spacing of approximately 2 mm to approximately 9 mm between planes. A medical image with an ultra-high resolution may use resolution of 512×512 with a spacing less than 1 mm between planes. A direction of the voxels in the medical image may be determined by the direction used to scan the subject and/or an orientation of the subject to the scanning system. In some embodiments, the first medical image has a certain MRI modality with a particular acquisition orientation, which results in a higher resolution in one direction and a lower resolution in another direction.

At step 104, the method 100 may include obtaining a second medical image of the subject, wherein the second medical image may have a plurality of voxels, including voxels in the portion of the region of interest where the first medical image is missing voxels. In particular, the first and second medical images reflect information of the same subject, but the first medical image contains less information or is less complete than the second medical image. For example, in some embodiments, the first medical image is missing voxels in a portion of the region of interest, and the second medical image has voxels in the portion of the region of interest where the first medical image is missing voxels. In some embodiments, the first medical image is missing slices in a portion of the region of interest, and the second medical image has slices in the portion of the region of interest where the first medical image is missing slices. In some embodiments, the first medical image is truncated in a portion of the region of interest, and the second medical image has voxels in the portion of the region of interest where the first medical image is missing voxels due to first medical image being truncated. In some embodiments, the first medical image has a low resolution in a portion of the region of interest, and the second medical image has a high resolution in the portion of the region of interest. For example, the first medical image may use resolution of 512×512 with a spacing of approximately 3 mm to approximately 5 mm between planes or a spacing of approximately 2 mm to approximately 9 mm between planes, and the second medical image may use resolution of 512×512 with a spacing of approximately 1 mm or less than 1 mm between planes. For example, the first medical image may be a rapidly obtained MRI image of the subject which is quicker but has a lower resolution than a second full resolution MRI medical image of the subject. For example, the first medical image may be a quicker check-up MRI medical image, and the second medical image may be an initial detailed MRI medical image of the subject, which may be used for diagnosing the subject. In some embodiments, the first medical image and the second medical image have a same magnetic resonance image (MRI) modality, and the first medical image and the second medical image have different acquisition orientations, resulting in the first medical image missing voxels compared to the second medical image.

In some embodiments, the first medical image and the second medical image may undergo pre-processing. In some embodiments, voxels with outlier values may be removed. For example, for each of the first medical image and the second medical image, outlier voxels that have distinctively high or low grey-levels that may affect the result of combining two images may be removed. By limiting the gray levels of an image to a certain percentile, such outlier voxels may be removed. In some embodiments, bias correction may be performed. For example, an issue with MRI images is bias of the magnetic field signal during acquisition, and bias correction may be used to decrease the impact such bias.

At step 106, the method 100 may include padding the first medical image to replace the missing voxels in the portion of the region of interest to obtain a padded first medical image.

At step 108, the method 100 may include padding the second medical image to replace any voxels missing in the portion of the region of interest to obtain a padded second medical image.

At step 110, the method 100 may include resampling the padded first medical image and the padded second medical image with a same spacing size to obtain a resampled first medical image and a resampled second medical image.

At step 112, the method 100 may include aligning the resampled second medical image to the resampled first medical image to obtain an aligned second medical image. By aligning the two medical images, the two medical images may have a same orientation and a same size for the subject. In some embodiments, aligning the resampled second medical image may include registering the resampled second medical image to the resampled first medical image using a rigid transformation. Registering two medical images may involve various methods, for example, applying landmarks or a Gaussian mixture model. In some embodiments, the rigid transformation may be an affine transformation. In other embodiments, the registration may use a non-rigid transformation (e.g., warping). In some embodiments, as a result of the aligning, the resampled second medical image and the resampled first medical image may have a same coordinate system and a same voxel size.

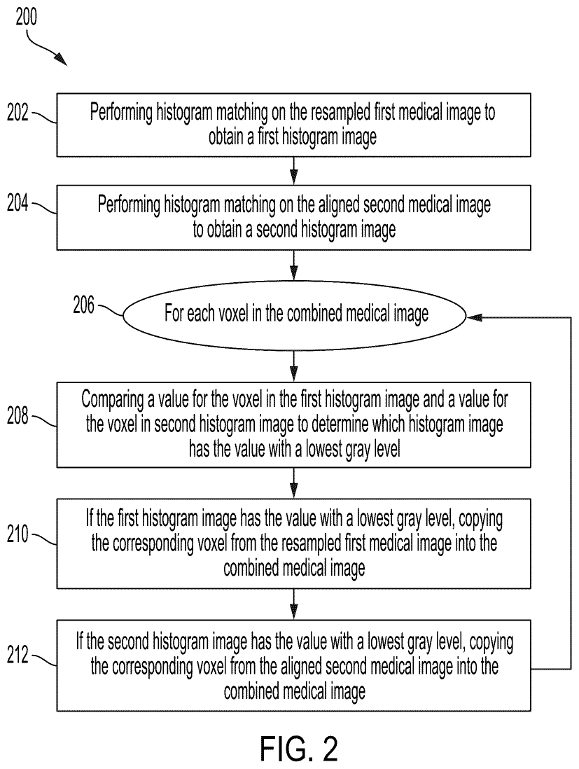

At step 114, the method 100 may include performing a same image processing on the resampled first medical image and the aligned second medical image to obtain a processed first medical image and a processed second medical image. More details regarding step 114 are illustrated in the descriptions for FIGS. 2-4.

At step 116, the method 100 may include generating a combined medical image based on the processed first medical image and the processed second medical image, where the combined medical image is not missing voxels or slices in the portion of the region of interest. More details about step 116 are illustrated in the descriptions for FIGS. 2-4.

In some embodiments, the method 100 may include introducing a third medical image when the combined medical image is missing voxels in a second portion of the region of interest (not shown). More specifically, the method 100 may include obtaining the third medical image of the subject, where the third medical image has a plurality of voxels, particularly voxels in the second portion of the region of interest. Further, the method 100 may include generating a second combined medical image based on the combined medical image and the third medical image, where the second combined medical image is not missing voxels in the second portion of the region of interest. In particular, generation of the second combined medical image may adopt a similar procedure as those described in steps 102-116.

At step 118, the method 100 may include generating at least one transducer location for delivering TTFields to the subject based on the combined medical image. With the combined medical image, a more complete view of the subject can be obtained having more information about the subject because the missing voxels in the first medical image are replaced with voxels having information on the subject. As the combined medical image has more information on the subject, a more accurate three-dimensional computational model of the subject can be obtained. With a more accurate three-dimensional computational model of the subject, a more accurate determination of where to place transducer arrays on the subject for delivering TTFields can be obtained.

In some embodiments, generating at least one transducer location for delivering TTFields to the subject based on the combined medical image may include: processing the combined medical image to determine the location of a tumor in the subject; assigning conductivities to tissue types of the subject based on the combined medical image; generating a three-dimensional model of the subject based on the combined medical image, conductivities of tissue types of the subject, and location of the tumor; simulating applying TTFields to the subject for numerous transducer locations on the subject using the three-dimensional model of the subject; calculating TTFields dosages for each of the simulated transducer locations; and selecting at least one transducer location to deliver TTFields to the subject.

Tuning to FIG. 2, FIG. 2 depicts an example method for executing steps 114 and 116 in FIG. 1 based on histograms, wherein steps 202 and 204 are examples to implement step 114 and steps 206-212 are examples to implement step 116.

At step 202, the method of performing a same image processing on the resampled first medical image, described at step 114 in FIG. 1, may include performing histogram matching on the resampled first medical image to obtain a first histogram image as the processed first medical image. Histogram matching may be performed, for example, according to any of the known techniques for doing so. In some embodiments, when the first medical image is missing slices in the portion of the region of interest, the first histogram image may be obtained by performing histogram matching on the first medical image.

At step 204, the method of performing a same image processing on the aligned second medical image, described at step 114 in FIG. 1, may include performing histogram matching on the aligned second medical image to obtain a second histogram image as the processed second medical image. In some embodiments, when the first medical image is missing slices in the portion of the region of interest, the second histogram image may be obtained by performing histogram matching on the second medical image.

In some embodiments, to perform histogram matching in steps 202 and 203, both medical images are of the same type (e.g., T1 MRI).

At step 206, the method may include repetitively performing steps 208-212 described below for each voxel in the combined medical image in order to generate the combined medical image as described at step 116 in FIG. 1.

At step 208, the method of generating the combined medical image, described at step 116 in FIG. 1, may include comparing a first value for the voxel in the first histogram image and a second value for the voxel in second histogram image to determine which histogram image has the value with a lowest gray level.

In some embodiments, the method of generating the combined medical image, described at step 116 in FIG. 1, may include comparing a value for the voxel in the first histogram image and a value for the voxel in second histogram image to determine which histogram image has the value with a lowest gray level.

At step 210, if the first histogram image has the value with a lowest gray level, the corresponding voxel from the resampled first medical image may be copied into the combined medical image. In some embodiments, upon comparing the value for the voxel in the first histogram image and the value for the voxel in second histogram image, if the first histogram image has the value with a lowest gray level, the corresponding voxel from the resampled first medical image is copied into the combined medical image.

At step 212, if the second histogram image has the value with a lowest gray level, the corresponding voxel from the aligned second medical image may be copied into the combined medical image. In some embodiments, upon comparing the value for the voxel in the first histogram image and the value for the voxel in second histogram image, if the second histogram image has the value with a lowest gray level, the corresponding voxel from the aligned second medical image is copied into the combined medical image.

Upon completion of the looping of steps 206-212, the combined medical image may be obtained as in step 116 of FIG. 1. As such, referring back to FIG. 1, in step 116, in some embodiments, the combined medical image may be generated based on the resampled first medical image, the aligned second medical image, the first histogram image, and the second histogram image, wherein the combined medical image has voxels missing in the first medical image.

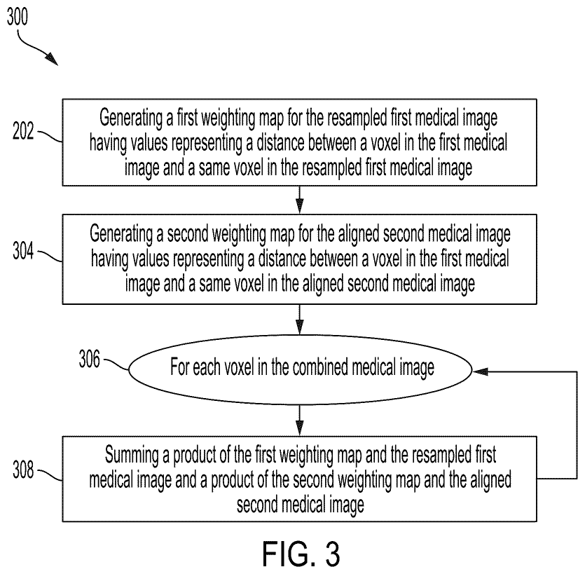

Turning to FIG. 3, FIG. 3 depicts an example method for executing steps 114 and 116 in FIG. 1 based on checkboard images, wherein steps 302 and 304 are examples to implement step 114 and steps 306 and 308 are examples to implement step 116.

At step 302, the method of performing a same image processing on the resampled first medical image, described at step 114 in FIG. 1, may include generating a first weighting map for the resampled first medical image. The first weighting map may have values, where each value represents a distance between a voxel in the first medical image and a same voxel in the resampled first medical image.

At step 304, the method of performing a same image processing on the aligned second medical image, described at step 114 in FIG. 1, may further include generating a second weighting map for the aligned second medical image. The second weighting map may have values representing a distance between a voxel in the second medical image and a same voxel in the aligned second medical image.

In some embodiments, the first weighting map and the second weighting map may be normalized individually or across the values of both maps.

At step 306, the method may include repetitively performing step 308 for each voxel in the combined medical image in order to generate the combined medical image as described at step 116 in FIG. 1.

At step 308, the method of generating the combined medical image, described at step 116 in FIG. 1, may include summing, for each voxel in the combined medical image, a product of the first weighting map and the resampled first medical image and a product of the second weighting map and the aligned second medical image. In some embodiments, the generation at step 308 may include summing first weighted values for voxels in the resampled first medical image and second weighted values for voxels in the aligned second medical image. The first weighted values may be based on a first weighting map having values representing a distance between a voxel in the first medical image and a same voxel in the resampled first medical image, and the second weighted values may be based on a second weighting map having values representing a distance between a voxel in the first medical image and a same voxel in the aligned second medical

In some embodiments, the generation at step 308 may include summing, for each voxel in the combined medical image, a first combination of a corresponding voxel in the processed first medical image and a corresponding voxel in the resampled first medical image, and a second combination of a corresponding voxel in the processed second medical image and a corresponding voxel in the aligned second medical image.

Upon completion of the looping of steps 306-308, the combined medical image may be obtained as in step 116 of FIG. 1. As such, referring back to FIG. 1, in step 116, in some embodiments, the combined medical image may be generated based on the first medical image, the second medical image, the first weighting map, and the second weighting map, wherein the combined medical image has voxels missing in the first medical image.

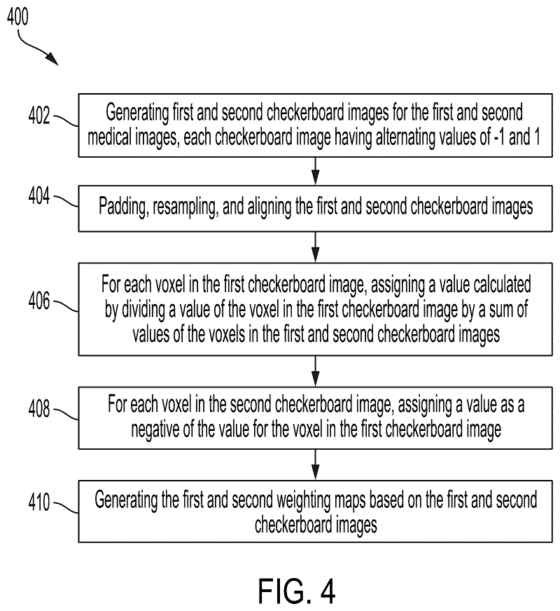

Turning to FIG. 4, FIG. 4 further depicts an example method for implementing steps 302 and 304 in FIG. 3.

At step 402, the method of generating the first weighting map and the second weighting map may include generating a first checkboard image and a second checkerboard image for the first and second medical images, respectively, In some embodiments, each checkerboard image may have alternating values of −1 and 1. In some embodiments, the generating method at step 402 may further include, for each voxel in the first checkerboard image, assigning a value calculated by dividing a value of the voxel in the first checkerboard image by a sum of values of the voxels in the first and second checkerboard images, and for each voxel in the second checkerboard image, assigning a value as a negative of the value for the voxel in the first checkerboard image.

At step 404, the method of generating the first weighting map and the second weighting map may include padding, resampling, and aligning the first and second checkerboard images. The techniques discussed above for steps 106, 108, 110, and 112 may be used to perform step 404 for the first and second checkerboard images.

At step 406, the method of generating the first weighting map and the second weighting map may include, for each voxel in the first checkerboard image, assigning a value calculated by dividing a value of the voxel in the first checkerboard image by a sum of values of the voxels in the first and second checkerboard images.

At step 408, the method of generating the first weighting map and the second weighting map may include, for each voxel in the second checkerboard image, assigning a value as a negative of the value for the voxel in the first checkerboard image.

At step 410, the method of generating the first weighting map and the second weighting map may include generating the first and second weighting maps based on the first and second checkerboard images. In some embodiments, the first and second weighting maps may be the first and second checkerboard images, respectively.

In some embodiments, the techniques for histogram matching as in FIG. 2 and for using checkerboard images as in FIGS. 3 and 4 may both be performed for step 114 in FIG. 1.

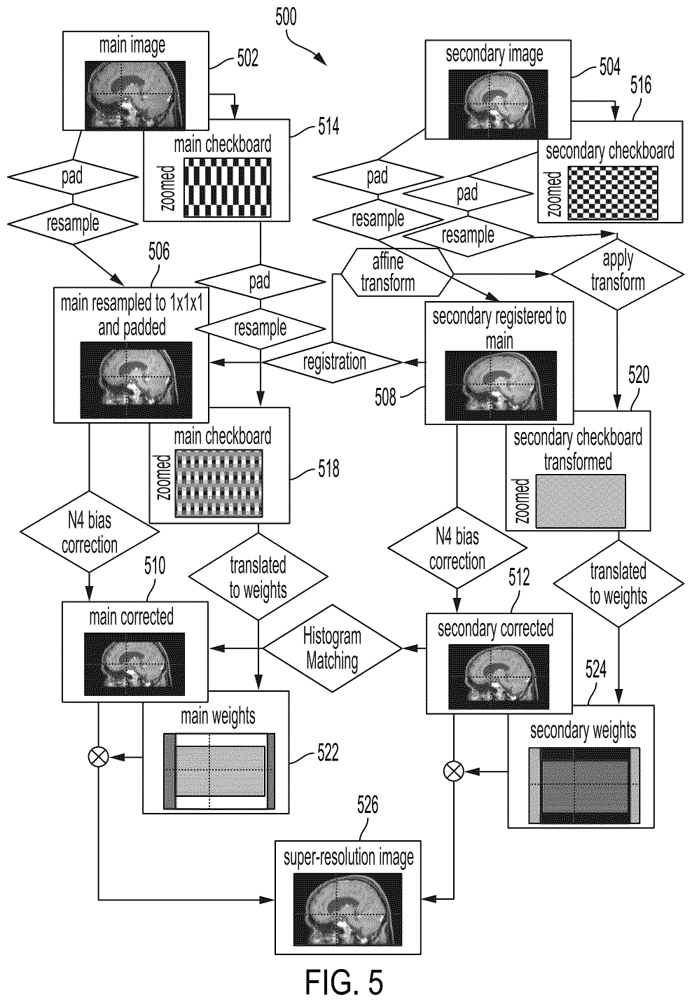

FIG. 5 depicts an example flowchart for performing the example method described in FIGS. 1-4. As in step 102, a main image 502 may be obtained, and as in step 104, a secondary image 504 may be obtained. In this example, the main image 502 has a lower resolution in a first direction compared to the secondary image 504, and as such, the main image 502 is missing voxels in the first direction. As in steps 106 and 108, the main image 502 may be padded and resampled to obtain a resampled main image 506. As in steps 106, 108, and 110, the secondary image 504 may be padded, resampled, and aligned with the main image to obtain an aligned second image 508. As part of pre-processing, the resampled main image 506 and the aligned second image 508 may have a bias correction (e.g., an N4 bias correction) applied to obtain a corrected main image 510 and a corrected secondary image 512. As in FIG. 2, histogram matching may further be performed on the corrected main image 510 and the corrected secondary image 512. As in step 402, a main checkerboard image 514 and a secondary checkerboard image 516 may be generated. As in block 404, the main checkerboard image 514 is padded and resampled to obtain a main checkerboard image 518. As in block 404, the secondary checkerboard image 514 may be padded, resampled, and aligned to obtain a secondary checkerboard image 520 using the same parameters as used to align the secondary image 504 with the main image 502. As in blocks 302, 304, 408 and 410, a main weighting map 522 and a secondary weighting map 524 may be generated. As in block 308, a super-resolution image 526 may be generated as the combined medical image using the corrected main image 510, the corrected secondary image 512, the main weighting map 522, and the secondary weighting map 524.

### Exemplary Systems and Apparatuses

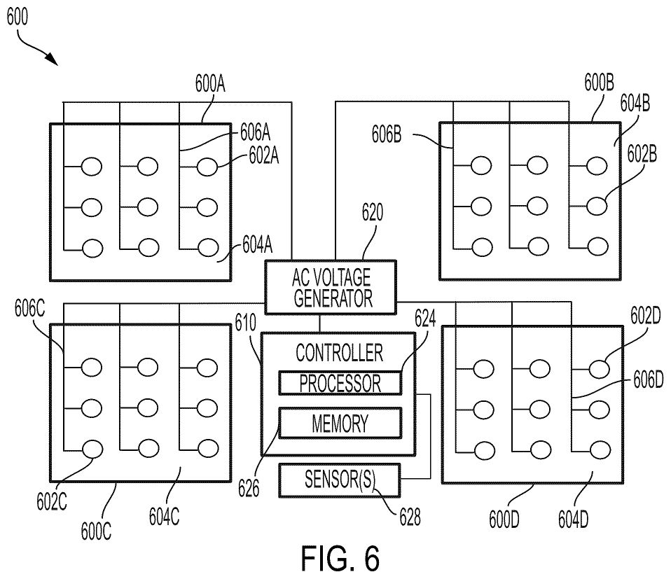

FIG. 6 depicts an example apparatus 600 to apply alternating electric fields (e.g., TTFields) to a subject's body. The system may be used for treating a target region of a subject's body with an alternating electric field. In an example, the target region may be in the subject's brain, and an alternating electric field may be delivered to the subject's body via two pairs of transducer arrays positioned on a head of the subject's body (such as, for example, in FIG. 8, which has four transducers 800). In another example, the target region may be in the subject's torso, and an alternating electric field may be delivered to the subject's body via two pairs of transducer arrays positioned on at least one of a thorax, an abdomen, or one or both thighs of the subject's body. Other transducer array placements on the subject's body may be possible.

The example apparatus 600 depicts an example system having four transducers (or “transducer arrays”) 600A-D. Each transducer 600A-D may include substantially flat electrode elements 602A-D positioned on a substrate 604A-D and electrically and physically connected (e.g., through conductive wiring 606A-D). For each substrate 604A-D, the respective electrode elements 602A-D of the substrate may be electrically connected to each other and may be physically connected to their respective substrate 604A-D. In an example, the electrode elements 602A-D may be controlled as a collective for each respective transducer 600A-D, such that the electrode elements 602A-D receive and execute a same instruction signal for each respective transducer 600A-D. In an example, the electrode elements 602A-D may be individually controlled for each respective transducer 600A-D, such that one electrode element may receive and execute an instruction different from an instruction received and executed by another electrode element of the respective transducer 600A-D.

The substrates 604A-D may include, for example, cloth, foam, flexible plastic, and/or conductive medical gel. Two transducers (e.g., 600A and 600D) may be a first pair of transducers configured to apply an alternating electric field to a target region of the subject's body. The other two transducers (e.g., 600B and 600C) may be a second pair of transducers configured to similarly apply an alternating electric field to the target region.

The transducers 600A-D may be coupled to an AC voltage generator 620, and the system may further include a controller 610 communicatively coupled to the AC voltage generator 620. The controller 610 may include a computer having one or more processors 624 and memory 626 accessible by the one or more processors. The memory 626 may store instructions that when executed by the one or more processors control the AC voltage generator 620 to induce alternating electric fields between pairs of the transducers 600A-D according to one or more voltage waveforms and/or cause the computer to perform one or more methods disclosed herein. The controller 610 may monitor operations performed by the AC voltage generator 620 (e.g., via the processor(s) 624). One or more sensor(s) 628 may be coupled to the controller 610 for providing measurement values or other information to the controller 610.

The electrode elements 602A-D may be capacitively coupled. In one example, the electrode elements 602A-D are ceramic electrode elements coupled to each other via conductive wiring 606A-D. When viewed in a direction perpendicular to its face, the ceramic electrode elements may be circular shaped or non-circular shaped. In other embodiments, the array of electrode elements are not capacitively coupled, and there is no dielectric material (such as ceramic, or high dielectric polymer layer) associated with the electrode elements.

In some embodiments, the voltage generation components may supply the transducers 600A-D with an electrical signal having an alternating current waveform at frequencies in a range from about 50 kHz to about 1 MHz and appropriate to deliver TTFields treatment to the subject's body.

The structure of the transducers 600A-D may take many forms. The transducers may be affixed to the subject's body or attached to or incorporated in clothing covering the subject's body. The transducer may include suitable materials for attaching the transducer to the subject's body. For example, the suitable materials may include cloth, foam, flexible plastic, and/or a conductive medical gel. The transducer may be conductive or non-conductive.

The transducer may include any desired number of electrode elements (e.g., one or more electrode elements). For example, the transducer may include one, two, three, four, five, six, seven, eight, nine, ten, or more electrode elements (e.g., twenty electrode elements). Various shapes, sizes, and materials may be used for the electrode elements. Any constructions for implementing the transducer (or electric field generating device) for use with embodiments of the invention may be used as long as they are capable of (a) delivering TTFields to the subject's body and (b) being positioned at the locations specified herein. In certain embodiments, at least one electrode element of the first, the second, the third, or the fourth transducer can include at least one ceramic disk that is adapted to generate an alternating electric field. In non-limiting embodiments, at least one electrode element of the first, the second, the third, or the fourth transducer includes a polymer film that is adapted to generate an alternating field.

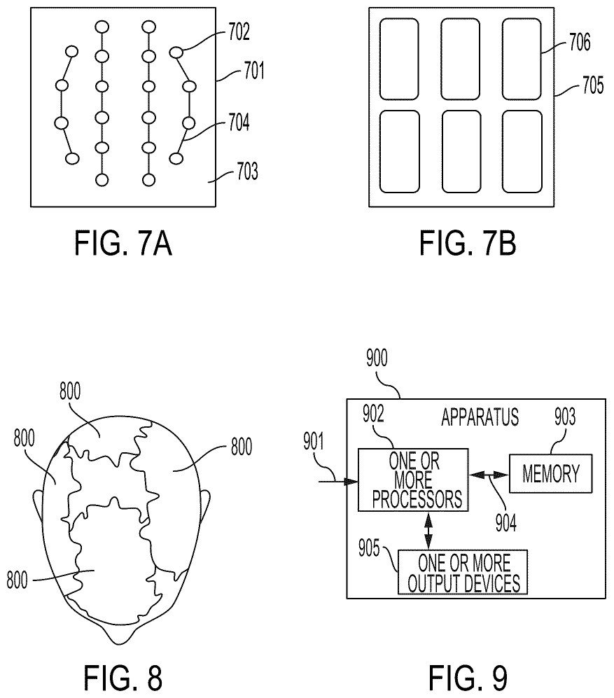

FIG. 7A depicts a schematic view of an exemplary design of a transducer for applying alternating electric fields. The transducer array 701 includes twenty electrode elements 702, which are positioned on the substrate 703, and the electrode elements 702 are electrically and physically connected to one another through a conductive wiring 704. In some embodiments, the electrode elements 702 can include a ceramic disk.

FIG. 7B depicts a schematic view of an exemplary design of a transducer for applying alternating electric fields. The transducer 705 can include substantially flat electrode elements 706, respectively. In some embodiments, the electrode elements 706 are non-ceramic dielectric materials positioned over a plurality of flat conductors. Examples of non-ceramic dielectric materials positioned over flat conductors may include polymer films disposed over pads on a printed circuit board or over substantially planar pieces of metal. In some embodiments, such polymer films have a high dielectric constant, such as, for example, a dielectric constant greater than 10. In some embodiments, the electrode elements 706 may have various shapes. For example, the electrode elements can be triangular, rectangular, circular, oval, ovaloid, ovoid, or elliptical in shape or substantially triangular, substantially rectangular, substantially circular, substantially oval, substantially ovaloid, substantially ovoid, or substantially elliptical in shape. In some embodiments, each of electrode elements 706 may have a same shape, similar shapes, and/or different shapes.

FIG. 9 depicts an example computer apparatus for use with the embodiments herein. As an example, the apparatus 900 may be a computer to implement certain inventive techniques disclosed herein, such as generating the combined medical image according to FIG. 1. For example, steps 102 to 118 of FIG. 1, steps 202 to 212 of FIG. 2, steps 302 to 308 of FIG. 3, and/or steps 402 to 410 of FIG. 4 may be performed by a computer, such as computer apparatus 900. As an example, the apparatus 900 may be used as the controller 610 of FIG. 6, or as a separate computer apparatus located remote from the controller 610. The apparatus 900 may include one or more processors 902, memory 903, one or more input devices, and one or more output devices 905.

In some embodiments, based on input 901, the one or more processors 902 may generate control signals to control the voltage generator to implement one or more embodiments described herein. As an example, the input 901 may be user input. As an example, the input 901 may be received from another computer in communication with the controller apparatus 900. The input 901 may be received in conjunction with one or more input devices (not shown) of the apparatus 900.

The memory 903 may be accessible by the one or more processors 902 (e.g., via a link 904) so that the one or more processors 902 may read information from and write information to the memory 903. The memory 903 may store instructions that, when executed by the one or more processors 902, implement one or more embodiments described herein.

The one or more output devices 905 may provide the status of the operation of the invention, such as transducer array selection, voltages being generated, and other operational information. The output device(s) 905 may provide visualization data according to certain embodiments of the invention.

The apparatus 900 may be an apparatus for enhancing a medical image, the apparatus including: one or more processors (such as one or more processors 902); and memory (such as memory 903) accessible by the one or more processors, the memory storing instructions that when executed by the one or more processors, cause the apparatus to perform one or more methods described herein.

The memory 903 may be a non-transitory processor readable medium containing a set of instructions thereon for enhancing a medical image, wherein when executed by a processor (such as processor 902), the instructions cause the processor to perform one or more methods described herein.

### ILLUSTRATIVE EMBODIMENTS

The invention includes other illustrative embodiments (“Embodiments”) as follows.

Embodiment 1: A computer-implemented method for enhancing a medical image, the method comprising: obtaining a first medical image of a subject, the first medical image having a plurality of voxels, the first medical image missing voxels in a portion of a region of interest; obtaining a second medical image of the subject, the second medical image having a plurality of voxels, the second medical image having voxels in the portion of the region of interest; and generating a combined medical image based on the first medical image and the second medical image, wherein the combined medical image is not missing voxels in the portion of the region of interest.

Embodiment 2: the method of Embodiment 1, wherein the first medical image is missing slices in the portion of the region of interest, wherein the second medical image has voxels in the portion of the region of interest where the first medical image is missing slices.

Embodiment 3: the method of Embodiment 1, wherein the first medical image is truncated in the region of interest, wherein the second medical image has voxels in the portion of the region of interest where the first medical image is truncated.

Embodiment 4: the method of Embodiment 1, wherein the first medical image has a lower resolution in a first direction than the second medical image.

Embodiment 5: the method of Embodiment 1, wherein the first medical image has a spacing of approximately 3 mm to approximately 5 mm between planes or spacing of approximately 2 mm to approximately 9 mm between planes, wherein the second medical image has a spacing of approximately 1 mm between planes or less than 1 mm between planes.

Embodiment 6: the method of Embodiment 1, wherein the first medical image and the second medical image have a same magnetic resonance image (MRI) modality, wherein the first medical image and the second medical image have different acquisition orientations.

Embodiment 7: the method of Embodiment 1, further comprising: padding the first medical image to replace the missing voxels in the portion of the region of interest to obtain a padded first medical image; padding the second medical image to replace any voxels missing in the portion of the region of interest to obtain a padded second medical image; resampling the padded first medical image and the padded second medical image with a same spacing size to obtain a resampled first medical image and a resampled second medical image; aligning the resampled second medical image to the resampled first medical image to obtain an aligned second medical image; and performing a same image processing on the resampled first medical image and the aligned second medical image to obtain a processed first medical image and a processed second medical image, wherein the combined medical image is generated based on the processed first medical image and the processed second medical image.

Embodiment 8: the method of Embodiment 7, wherein aligning the resampled second medical image comprises registering the resampled second medical image to the resampled first medical image using a rigid transformation.

Embodiment 9: the method of Embodiment 7, wherein the resampled second medical image and the resampled first medical image have a same coordinate system and a same voxel size.

Embodiment 10: the method of Embodiment 7, wherein performing the same image processing comprises: performing histogram matching on the resampled first medical image; and performing histogram matching on the aligned second medical image.

Embodiment 11: the method of Embodiment 7, wherein generating the combined medical image comprises comparing values for voxels in the processed first medical image and values for voxels in the processed second medical image to determine voxels for the combined medical image.

Embodiment 12: the method of Embodiment 11, wherein the values for voxels in the processed first medical image are based on a histogram matching of the first medical image, and wherein the values for voxels in the processed second medical image are based on a histogram matching of the second medical image.

Embodiment 13: the method of Embodiment 7, wherein performing the same image processing comprises: generating a first weighting map for the resampled first medical image; and generating a second weighting map for the aligned second medical image.

Embodiment 14: the method of Embodiment 13, wherein the first weighting map has values representing a distance between a voxel in the first medical image and a same voxel in the resampled first medical image, and wherein the second weighting map has values representing a distance between a voxel in the first medical image and a same voxel in the aligned second medical image.

Embodiment 15: the method of Embodiment 7, wherein performing the same image processing comprises: performing histogram matching on the resampled first medical image; performing histogram matching on the aligned second medical image; generating a first weighting map for the resampled first medical image; and generating a second weighting map for the aligned second medical image.

Embodiment 16: the method of Embodiment 7, wherein generating the combined medical image comprises: for each voxel in the combined medical image, summing a first combination of a corresponding voxel in the processed first medical image and a voxel corresponding in the resampled first medical image, and a second combination of a corresponding voxel in the processed second medical image and a corresponding voxel in the aligned second medical image.

Embodiment 17: the method of Embodiment 7, wherein generating the combined medical image comprises summing first weighted values for voxels in the resampled first medical image and second weighted values for voxels in the aligned second medical image, wherein the first weighted values are based on a first weighting map having values representing a distance between a voxel in the first medical image and a same voxel in the resampled first medical image; wherein the second weighted values are based on a second weighting map having values representing a distance between a voxel in the first medical image and a same voxel in the aligned second medical image.

Embodiment 18: the method of Embodiment 1, wherein the combined medical image is missing voxels in a second portion of the region of interest, wherein the method further comprises: obtaining a third medical image of the subject, the third medical image having a plurality of voxels, the third medical image having voxels in the second portion of the region of interest; and generating a second combined medical image based on the combined medical image and the third medical image, wherein the second combined medical image is not missing voxels in the second portion of the region of interest.

Embodiment 19: the method of Embodiment 1, further comprising: generating at least one transducer location for delivering tumor treating fields to the subject based on the combined medical image.

Embodiment 20: A computer-implemented method for enhancing a medical image, the method comprising: obtaining a first medical image of a subject, the first medical image having a plurality of voxels, the first medical image missing slices in a portion of a region of interest; obtaining a second medical image of the subject, the second medical image having a plurality of voxels, wherein the second medical image has voxels in the portion of the region of interest where the first medical image is missing slices; performing histogram matching on the first medical image to obtain a first histogram image; performing histogram matching on the second medical image to obtain a second histogram image; and generating a combined medical image based on the resampled first medical image, the aligned second medical image, the first histogram image, and the second histogram image, wherein the combined medical image is not missing slices in the portion of the region of interest.

Embodiment 21: the method of Embodiment 20, wherein generating the combined medical image comprises: for each voxel in the combined medical image, comparing a value for the voxel in the first histogram image and a value for the voxel in second histogram image to determine which histogram image has the value with a lowest gray level; if the first histogram image has the value with a lowest gray level, copying the corresponding voxel from the resampled first medical image into the combined medical image; and if the second histogram image has the value with a lowest gray level, copying the corresponding voxel from the aligned second medical image into the combined medical image.

Embodiment 22: A computer-implemented method for enhancing a medical image, the method comprising: obtaining a first medical image of a subject, the first medical image having a plurality of voxels; obtaining a second medical image of the subject, the second medical image having a plurality of voxels, wherein the first medical image has a lower resolution in a first direction than the second medical image; generating a first weighting map for the first medical image having values representing a distance between a voxel in the first medical image and a same voxel in a resampled first medical image; generating a second weighting map for the second medical image having values representing a distance between a voxel in the first medical image and a same voxel in a resampled second medical image; and generating a combined medical image based on the first medical image, the second medical image, the first weighting map, and the second weighting map, wherein the combined medical image has the lower resolution in the first direction.

Embodiment 23: the method of Embodiment 22, wherein generating the first weighting map comprises generating a first checkerboard image for the first medical image, and wherein generating the second weighting map comprises generating a second checkerboard image for the second medical image.

Embodiment 24: the method of Embodiment 22, wherein generating the first weighting map and the second weighting map comprises: generating first and second checkerboard images for the first and second medical images, each checkerboard image having alternating values of −1 and 1; for each voxel in the first checkerboard image, assigning a value calculated by dividing a value of the voxel in the first checkerboard image by a sum of values of the voxels in the first and second checkerboard images; for each voxel in the second checkerboard image, assigning a value as a negative of the value for the voxel in the first checkerboard image; and generating the first and second weighting maps based on the first and second checkerboard images.

Embodiment 25: the method of Embodiment 22, wherein generating the combined medical image comprises: for each voxel, summing a product of the first weighting map and the resampled first medical image and a product of the second weighting map and the resampled second medical image.

Embodiment 26: An apparatus for selecting transducer locations for delivering tumor treating fields to a subject, the apparatus comprising: one or more processors; and memory accessible by the one or more processors, the memory storing instructions that when executed by the one or more processors, cause the apparatus to perform a method comprising: obtaining a first medical image of a subject, the first medical image having a plurality of voxels, the first medical image missing voxels in a portion of a region of interest; obtaining a second medical image of the subject, the second medical image having a plurality of voxels, the second medical image having voxels in the portion of the region of interest; and generating a combined medical image based on the first medical image and the second medical image, wherein the combined medical image is not missing voxels in the portion of the region of interest.

Embodiment 27: A non-transitory processor readable medium containing a set of instructions thereon that when executed by a processor cause the processor to perform a method comprising: obtaining a first medical image of a subject, the first medical image having a plurality of voxels, the first medical image missing voxels in a portion of a region of interest; obtaining a second medical image of the subject, the second medical image having a plurality of voxels, the second medical image having voxels in the portion of the region of interest; and generating a combined medical image based on the first medical image and the second medical image, wherein the combined medical image is not missing voxels in the portion of the region of interest.

Embodiment 28: An apparatus for selecting transducer locations for delivering tumor treating fields to a subject, the apparatus comprising: one or more processors; and memory accessible by the one or more processors, the memory storing instructions that when executed by the one or more processors, cause the apparatus to perform a method comprising: obtaining a first medical image of a subject, the first medical image having a plurality of voxels, the first medical image missing slices in a portion of a region of interest; obtaining a second medical image of the subject, the second medical image having a plurality of voxels, wherein the second medical image has voxels in the portion of the region of interest where the first medical image is missing slices; performing histogram matching on the first medical image to obtain a first histogram image; performing histogram matching on the second medical image to obtain a second histogram image; and generating a combined medical image based on the resampled first medical image, the aligned second medical image, the first histogram image, and the second histogram image, wherein the combined medical image is not missing slices in the portion of the region of interest.

Embodiment 29: A non-transitory processor readable medium containing a set of instructions thereon that when executed by a processor cause the processor to perform a method comprising: obtaining a first medical image of a subject, the first medical image having a plurality of voxels, the first medical image missing slices in a portion of a region of interest; obtaining a second medical image of the subject, the second medical image having a plurality of voxels, wherein the second medical image has voxels in the portion of the region of interest where the first medical image is missing slices; performing histogram matching on the first medical image to obtain a first histogram image; performing histogram matching on the second medical image to obtain a second histogram image; and generating a combined medical image based on the resampled first medical image, the aligned second medical image, the first histogram image, and the second histogram image, wherein the combined medical image is not missing slices in the portion of the region of interest.

Embodiment 30: An apparatus for selecting transducer locations for delivering tumor treating fields to a subject, the apparatus comprising: one or more processors; and memory accessible by the one or more processors, the memory storing instructions that when executed by the one or more processors, cause the apparatus to perform a method comprising: obtaining a first medical image of a subject, the first medical image having a plurality of voxels; obtaining a second medical image of the subject, the second medical image having a plurality of voxels, wherein the first medical image has a lower resolution in a first direction than the second medical image; generating a first weighting map for the first medical image having values representing a distance between a voxel in the first medical image and a same voxel in a resampled first medical image; generating a second weighting map for the second medical image having values representing a distance between a voxel in the first medical image and a same voxel in a resampled second medical image; and generating a combined medical image based on the first medical image, the second medical image, the first weighting map, and the second weighting map, wherein the combined medical image has the lower resolution in the first direction.

Embodiment 31: A non-transitory processor readable medium containing a set of instructions thereon that when executed by a processor cause the processor to perform a method comprising: obtaining a first medical image of a subject, the first medical image having a plurality of voxels; obtaining a second medical image of the subject, the second medical image having a plurality of voxels, wherein the first medical image has a lower resolution in a first direction than the second medical image; generating a first weighting map for the first medical image having values representing a distance between a voxel in the first medical image and a same voxel in a resampled first medical image; generating a second weighting map for the second medical image having values representing a distance between a voxel in the first medical image and a same voxel in a resampled second medical image; and generating a combined medical image based on the first medical image, the second medical image, the first weighting map, and the second weighting map, wherein the combined medical image has the lower resolution in the first direction.

Embodiments illustrated under any heading or in any portion of the disclosure may be combined with embodiments illustrated under the same or any other heading or other portion of the disclosure unless otherwise indicated herein or otherwise clearly contradicted by context. For example, and without limitation, embodiments described in dependent claim format for a given embodiment (e.g., the given embodiment described in independent claim format) may be combined with other embodiments (described in independent claim format or dependent claim format).

Numerous modifications, alterations, and changes to the described embodiments are possible without departing from the scope of the present invention defined in the claims. It is intended that the present invention not be limited to the described embodiments, but that it has the full scope defined by the language of the following claims, and equivalents thereof.

What is claimed is:

1. A computer-implemented method for enhancing a medical image, the method comprising:
obtaining a first medical image of a subject, the first medical image having a plurality of voxels, the first medical image missing voxels in a portion of a region of interest;
obtaining a second medical image of the subject, the second medical image having a plurality of voxels, the second medical image having voxels in the portion of the region of interest; and
generating a combined medical image based on the first medical image and the second medical image, wherein the combined medical image is not missing voxels in the portion of the region of interest.

2. The method of claim 1, wherein the first medical image is missing slices in the portion of the region of interest, wherein the second medical image has voxels in the portion of the region of interest where the first medical image is missing slices.

3. The method of claim 1, wherein the first medical image is truncated in the region of interest, wherein the second medical image has voxels in the portion of the region of interest where the first medical image is truncated.

4. The method of claim 1, wherein the first medical image has a lower resolution in a first direction than the second medical image.

5. The method of claim 1, wherein the first medical image and the second medical image have a same magnetic resonance image (MRI) modality, wherein the first medical image and the second medical image have different acquisition orientations.

6. The method of claim 1, further comprising:
padding the first medical image to replace the missing voxels in the portion of the region of interest to obtain a padded first medical image;
padding the second medical image to replace any voxels missing in the portion of the region of interest to obtain a padded second medical image;
resampling the padded first medical image and the padded second medical image with a same spacing size to obtain a resampled first medical image and a resampled second medical image;
aligning the resampled second medical image to the resampled first medical image to obtain an aligned second medical image; and
performing a same image processing on the resampled first medical image and the aligned second medical image to obtain a processed first medical image and a processed second medical image,
wherein the combined medical image is generated based on the processed first medical image and the processed second medical image.

7. The method of claim 6, wherein aligning the resampled second medical image comprises registering the resampled second medical image to the resampled first medical image using a rigid transformation.

8. The method of claim 6, wherein performing the same image processing comprises:
performing histogram matching on the resampled first medical image; and
performing histogram matching on the aligned second medical image.

9. The method of claim 6, wherein generating the combined medical image comprises comparing values for voxels in the processed first medical image and values for voxels in the processed second medical image to determine voxels for the combined medical image.

10. The method of claim 9, wherein the values for voxels in the processed first medical image are based on a histogram matching of the first medical image, and wherein the values for voxels in the processed second medical image are based on a histogram matching of the second medical image.

11. The method of claim 6, wherein performing the same image processing comprises:
generating a first weighting map for the resampled first medical image; and
generating a second weighting map for the aligned second medical image.

12. The method of claim 11, wherein the first weighting map has values representing a distance between a voxel in the first medical image and a same voxel in the resampled first medical image, and
wherein the second weighting map has values representing a distance between a voxel in the first medical image and a same voxel in the aligned second medical image.

13. The method of claim 6, wherein performing the same image processing comprises:
performing histogram matching on the resampled first medical image;
performing histogram matching on the aligned second medical image;
generating a first weighting map for the resampled first medical image; and
generating a second weighting map for the aligned second medical image.

14. The method of claim 6, wherein generating the combined medical image comprises:
for each voxel in the combined medical image, summing
a first combination of a corresponding voxel in the processed first medical image and a voxel corresponding in the resampled first medical image, and
a second combination of a corresponding voxel in the processed second medical image and a corresponding voxel in the aligned second medical image.

15. The method of claim 1, further comprising:
generating at least one transducer location for delivering tumor treating fields to the subject based on the combined medical image.

16. A computer-implemented method for enhancing a medical image, the method comprising:
obtaining a first medical image of a subject, the first medical image having a plurality of voxels, the first medical image missing slices in a portion of a region of interest;
obtaining a second medical image of the subject, the second medical image having a plurality of voxels, wherein the second medical image has voxels in the portion of the region of interest where the first medical image is missing slices;
performing histogram matching on the first medical image to obtain a first histogram image;
performing histogram matching on the second medical image to obtain a second histogram image; and
generating a combined medical image based on the resampled first medical image, the aligned second medical image, the first histogram image, and the second histogram image, wherein the combined medical image is not missing slices in the portion of the region of interest.

17. The method of claim 16, wherein generating the combined medical image comprises:
for each voxel in the combined medical image,
comparing a value for the voxel in the first histogram image and a value for the voxel in second histogram image to determine which histogram image has the value with a lowest gray level;
if the first histogram image has the value with a lowest gray level, copying the corresponding voxel from the resampled first medical image into the combined medical image; and
if the second histogram image has the value with a lowest gray level, copying the corresponding voxel from the aligned second medical image into the combined medical image.

18. A computer-implemented method for enhancing a medical image, the method comprising:
obtaining a first medical image of a subject, the first medical image having a plurality of voxels;
obtaining a second medical image of the subject, the second medical image having a plurality of voxels, wherein the first medical image has a lower resolution in a first direction than the second medical image;
generating a first weighting map for the first medical image having values representing a distance between a voxel in the first medical image and a same voxel in a resampled first medical image;
generating a second weighting map for the second medical image having values representing a distance between a voxel in the first medical image and a same voxel in a resampled second medical image; and
generating a combined medical image based on the first medical image, the second medical image, the first weighting map, and the second weighting map, wherein the combined medical image has the lower resolution in the first direction.

19. The method of claim 18, wherein generating the first weighting map comprises generating a first checkerboard image for the first medical image, and
wherein generating the second weighting map comprises generating a second checkerboard image for the second medical image.

20. The method of claim 18, wherein generating the combined medical image comprises:
for each voxel, summing a product of the first weighting map and the resampled first medical image and a product of the second weighting map and the resampled second medical image.
